(19) United States
(12) Patent Application Publication
(10) Pub. No.: US 2011/0061277 A1
(43) Pub. Date: Mar. 17, 2011

(54) Easel display board with two-way integral foot

(75) Inventors: Maria Forte Demott, Stamford, CT (US); Steven R. Fink, Stamford, CT (US)

(73) Assignee: Royal Consumer Products, LLC

(21) Appl. No.: 12/806,588

(22) Filed: Aug. 16, 2010

Related U.S. Application Data
(60) Provisional application No. 61/274,524, filed on Aug. 17, 2009.

(51) Int. Cl. G09F 15/00; B32B 37/12

(52) U.S. Cl. 40/606.15; 156/60

(57) ABSTRACT

A display board has a front layer with display surface and an opposite laminating surface, and a rear layer having substantially the same size and shape as the front layer. The rear layer has an integral foot and a brace arm separated from the remaining rear layer by cut lines. The rear layer is laminated to the laminating surface to the front layer with the integral foot and brace arm thereof not laminated to the front layer, wherein the integral foot and brace arm are foldably extendable from the rear layer interengageable to support the display board in an upright position on a surface, in either portrait or landscape orientation.

### RELATED APPLICATION

This Application claims priority to U.S. Provisional Application Ser. No. 61/274,524 filed Aug. 17, 2009.

### FIELD OF INVENTION

This invention relates to a display board that has a deployable, integral foot for supporting the display board in portrait or landscape orientation.

### BACKGROUND OF THE INVENTION

Presentation of information represented by indicia and images is often achieved with posterboard. Posterboard may be hung on a wall or supported by an easel for presentation of the information. Posterboard does not stand alone without some means of support. This provides a limited number of options for presenting the information. For instance, in some situations, it is not feasible or permissible to hang a posterboard on a wall with pushpins or tape, and an easel or similar type support is not available.

Accordingly, there is a need for an improvement in a device for displaying information that is self-supporting.

### SUMMARY OF INVENTION

It is principal object of the invention herein to provide a self-supporting display board for presenting information.

It is an additional object of the invention to provide a self-supporting display board that may also be used as a flat posterboard.

It is also an object of the invention herein to provide a display board for presenting information that is self-supporting in portrait and landscape orientation.

It is a further object of the invention herein to provide a method of making a self-supporting display board.

In carrying out the invention herein, a display board is provided including a front layer with a display surface for receiving indicia and images and a laminating surface opposite the display surface. A rear layer of substantially the same size and shape as the front layer is provided, the rear layer having an integral foot with a proximate foot end integrally hingedly connected to the remaining part of the rear layer at a fold line, and the remaining portion of the integral foot including a distal foot end separated from the remaining portion of the rear layer by cut lines. The rear layer is adhered to the laminating surface of the front layer with the integral foot thereof not laminated to the front layer, wherein the integral foot is foldably extendable from the rear layer to support the display board in upright position on a surface.

In additional aspects of the invention, brace means are provided for establishing a fixed extended position of the integral foot. In a specific aspect, the brace means is a brace arm integral with the rear layer with a proximate brace arm end integrally hingedly connected to the remaining part of the rear layer at a fold line. The remaining portion of the brace arm separated from the remaining part of the rear layer by cut lines. The brace arm is not laminated to the front layer. In a related aspect of the invention, the brace arm and the integral foot are releaseably interengageable to hold the integral foot in its fixed extended position.

In another specific aspect of the invention, the integral foot defines a slot and a distal end of the brace arm is configured as a tab receivable in the slot of the integral foot to hold the integral foot in its fixed extended position. In an alternative specific aspect of the invention, the integral foot and the brace arm each define notches that are interengageable to hold the integral foot in its fixed extendable position.

The integral foot may be positioned with the integral foot end at a corner of a rectangular display board, with edges for supporting the display board in portrait or landscape orientation. The integral foot may also be positioned as an interior portion of the rear layer, and may have edges for supporting a rectangular display board in portrait or landscape position.

In another aspect of the invention, the front layer an the rear layer are each corrugated panels, providing a stiff, lightweight display board. The display surface of the front layer may be provided on an outer paper or paperboard skin adhered to the front layer corrugated panel, or the display surface may be provided by a coating applied to the front layer corrugated panel. The front layer and rear layer corrugated panels are laminated together by glue, with the integral foot and brace arm not laminated.

In additional aspects of the invention, the front layer of the display board is paperboard stock, which may be of the type referred to art board or posterboard, and the rear layer is also paperboard stock. The two layers of paperboard stock are laminated together by glue with the integral foot and brace arm not being laminated. In another aspect, the rear layer may be paperboard having fluted corrugate thereon. The rear layer is laminated to the front layer with the corrugate adhered to the laminating surface of the front layer, except for the integral foot and brace arm. As alternative aspects, the front layer may be plastic, such as vinyls, polypropylenes or polyethylenes. The rear layer may also be other materials.

In further aspects of the invention, the display board is rectangular and the extended position of the foot supports the display board on a surface in portrait or landscape orientation. The display board may have the dimensions 22″×28″, or a similar or different size. As alternative aspects, the display board may have other polygonal or rounded shapes.

In another aspect of the invention, the cut lines separating the integral foot and the integral brace arm from the remaining portions of the rear layer are at least in part discontinuous cut lines separated by tear-away webs, whereby the integral foot and integral brace arm are maintained in their unfolded, flat condition as part of the rear layer until it is desired to deploy them, and the webs are torn as the integral foot and integral brace arm are deployed. Alternatively, the cut lines fully define the integral foot and brace arm, which are secured by one or more spots of adhesive that the user can readily release. The integral foot and brace arm may also be secured as undeployed portions of the rear layer by friction along the cut lines, and a cutout may be provided to facilitate extending the integral foot and brace arm.

Also in carrying out the invention herein, the method of making the display board includes providing a die for applying adhesive to one of the laminating surfaces of the front layer or the rear layer, wherein the die does not apply adhesive to the locations of the integral foot and integral brace arm. The die may, however, apply a small amount of adhesive to the areas of the integral foot and brace arm for releasably securing them. The rear layer is positioned on the laminating surface of the front layer, such that the integral foot and integral brace arm are not laminated to the front layer. The cut lines forming the integral foot and integral brace arm may be formed either before or after the step of laminating.

The method of making the display board may alternatively include applying adhesive in a pattern that does not adhere the integral foot and brace arm to the front layer and applying adhesive in ways other than a die.

Other features and objects of the invention herein will also appear from the following detailed description of the invention and claims, taken together with the drawings.

### BRIEF DESCRIPTION OF DRAWINGS

FIG. 1 is a plan view of the rear of a display board according to the invention herein;

FIG. 2 is a sectional view of the display board of FIG. 1, taken along the lines 2-2 of FIG. 1;

FIG. 3 is a side elevation view of the display board of FIG. 1, with an integral foot and brace arm thereof deployed;

FIG. 4 is a rear elevation view of the display board of FIG. 1 with the integral foot and brace arm deployed to support the display board in portrait orientation;

FIG. 5 is a rear elevation view of the display board of FIG. 1 with the integral foot and brace arm deployed to support the display board in landscape orientation;

FIG. 6 is a rear view of the front layer of the display board of FIG. 1, with adhesive applied thereto in preparation for laminating the rear panel thereto;

FIG. 7 is a sectional view of another display board according to the invention herein;

FIG. 8 is a rear view of another display board according to the invention herein;

FIG. 9 is a fragmentary sectional view of the display board of FIG. 8;

FIG. 10 is a side view of the display board of FIG. 8, in an erected position; and

FIG. 11 is a rear view of another display board according to the invention herein.

The same reference numerals refer to the same elements through out the various figures.

### DETAILED DESCRIPTION OF INVENTION

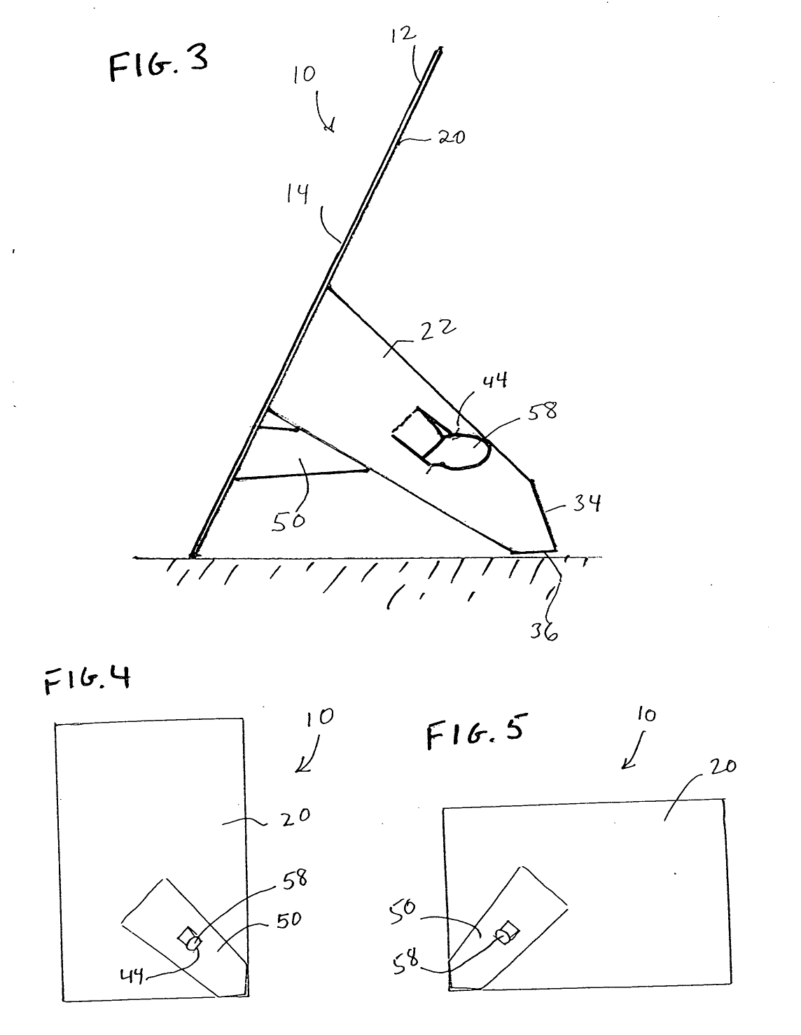

With reference to FIGS. 1-6, display board 10 according to the invention herein has a front layer 12 having a display surface 14 and a laminating surface 16 opposite the display surface 14. A rear layer 20 having an integral foot 22 and an integral brace arm 24 is adhered or laminated to the laminating surface 16 of the front layer 12, except that the integral foot 22 and integral brace arm 24 are not laminated to the front layer 12. The integral foot 22 and integral brace arm 24 may be deployed as illustrated in FIGS. 3-5 such that the display board 10 is supported in easel-like manner in either a landscape or portrait orientation.

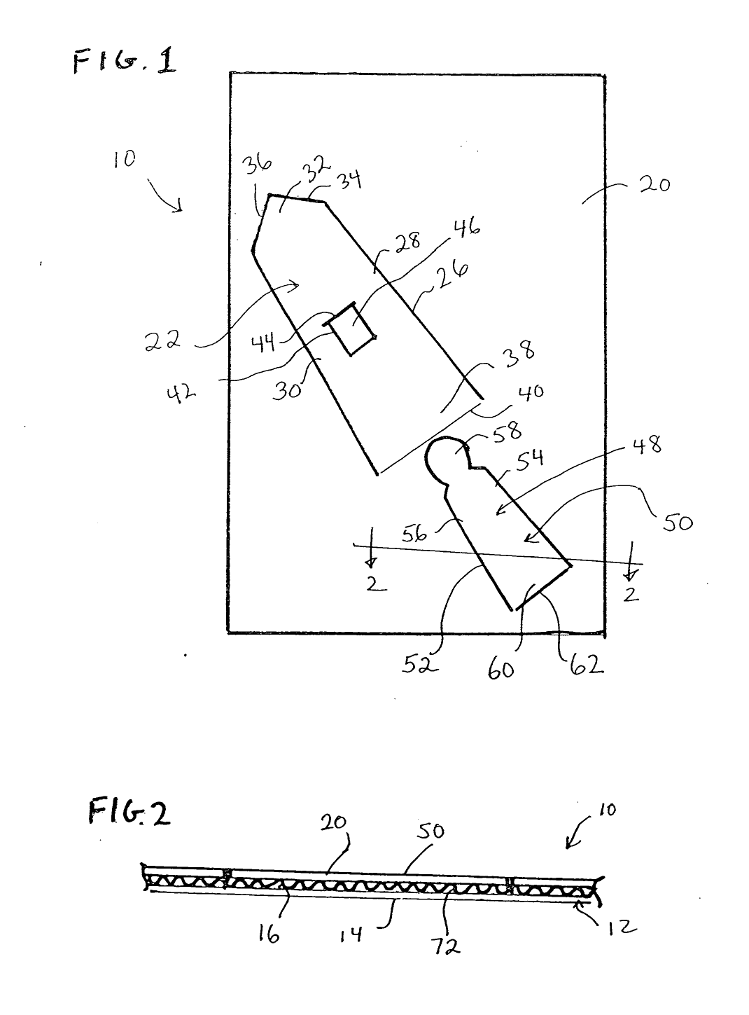

With reference to FIGS. 1 and 2 the integral foot 22 is separated from the remaining portion of the rear layer 20 by a cut line 26 that extends along sides 28 and 30 of the integral foot 22 and the cut line 26 also defines a distal foot end 32 of the integral foot 22. The distal foot end 32 preferably has two straight edges 34 and 36 which facilitate supporting the display board 10 in the portrait and landscape positions shown in FIGS. 4 and 5.

The proximate end 38 of integral foot 22 is integrally connected with the remaining portion of the rear layer 20 at a fold line 40, which may be formed by a crease in the rear layer 20. The integral foot 22 also has a cut line 42 defining a slot 44 and rectangular fill piece 46, which may be folded from the integral foot 22 to provide access to slot 44 as best seen in FIG. 4. The slot 44 is wider than the fill piece 46, so that the ends of the slot 44 are operative portions thereof.

The display board 10 also includes a brace means 48 which in the embodiment shown is a brace arm 50 integral with the rear layer 20. The brace arm 50 is separated from the remaining portions of the rear layer by cut line 52 which define the sides 54 and 56 and a distal brace arm end 58 of the brace arm 50. A proximate end 60 of the brace arm 50 is connected to the remaining portion of the rear layer 20 at fold line 62.

The cut lines 26, 42 and 52 may be at least in part discontinuous, such that small webs remain and retain the integral foot 22, the fill piece 46 and the integral brace arm 50 in planar, attached condition with respect to the remaining portions of the rear layer 20 until such time as the webs are torn to deploy the foot 22 and brace arm 50. This permits the display board 10 to be used in the same manner as a posterboard. The discontinuous portions of the cut lines may be localized near the distal ends 32 and 58 of the integral foot 22 and brace arm 50, respectively, or may be widely spaced webs along the cut lines.

Alternatively, the cut lines 26, 42 and 52 are substantially complete and the integral foot 22 and brace arm 50 are held in their undeployed positions by one or more spots of adhesive, which may be provided on two-sided tape or may be glue provided in the laminating process. The amount of adhesive is such that the user can easily release the integral foot 22 and brace arm 50 when it is desired to deploy them.

If the cutlines are sufficiently thin, it has also been found that the integral foot 22 and brace arm 50 may be held in planar, undeployed condition by friction, wherein no webs or adhesives are necessary.

The front layer 12 of the display board 10 is paperboard stock of the type known as art board or poster board. It typically has a thickness of 10-14points and the display surface 14 is coated, calendered or otherwise processed to provide a smooth surface for receiving indicia or images comprising the information to be presented. The display surface may be colored, if desired. The front layer 14 may also be made of any other suitable material providing a relatively smooth surface for presenting information. Plastics, such as vinyls, polypropylenes and polyethylenes, may be suitable and have the advantage of being water-resistant. They may also be used as coatings over paperboard, for that purpose. The display board may have dimensions of 22″×28″, or may have similar or other dimensions.

As best seen in FIG. 2, the rear layer 20 includes an outer panel 70 of paperboard stock and fluted corrugate 72 secured to an inside surface thereof by adhesive. The rear layer may also be paperboard, i.e. without flutes, or may be other substrates, such as vinyls, polyethylenes, polypropylenes, or other suitable material. The rear layer is sufficiently stiff that the integral foot 22 adequately supports the display board 10, and the front layer and rear layer together are sufficiently thick and stiff that the display board 10 does not sag or bend excessively. It will be appreciated that the thicknesses may vary with the size of the display board 10, i.e. a smaller display board 10 would require stock with less stiffness and a larger display board 10 would require thicker, stiffer stock.

Although the display board 10 is shown having a rectangular shape, it will be appreciated that other shapes may be provided, such as other polygonal shapes, ovals, circles, or irregular shapes, so long as the foot and brace arm are accommodated within the shape in a position to support the display board when extended.

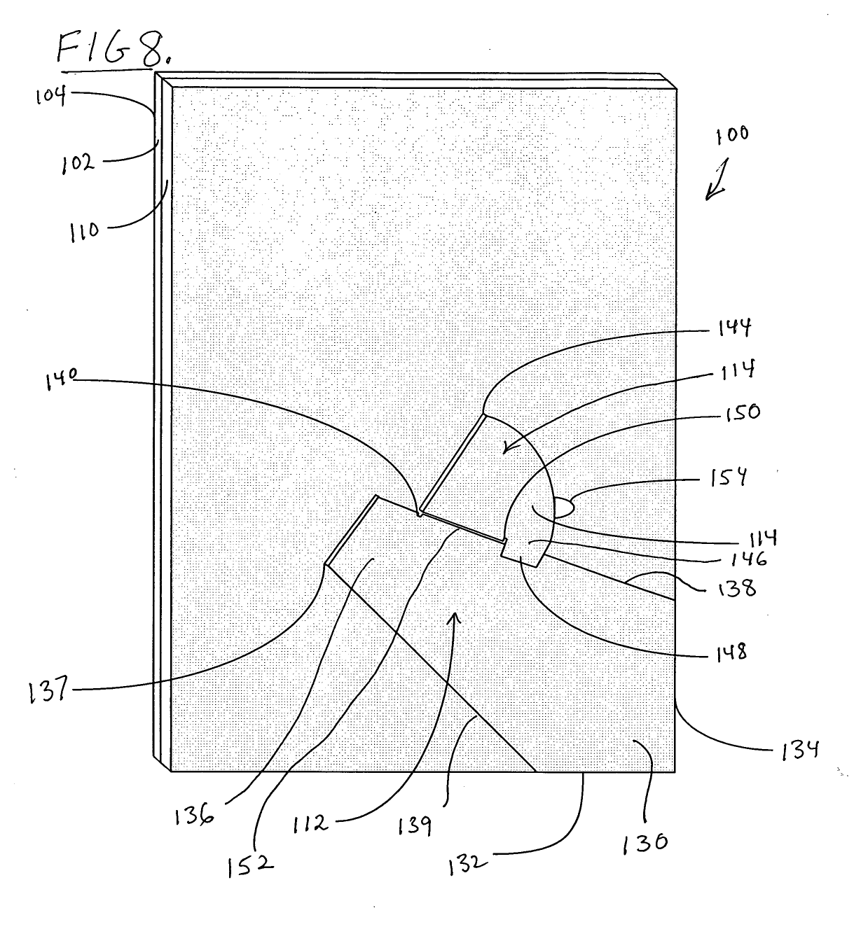

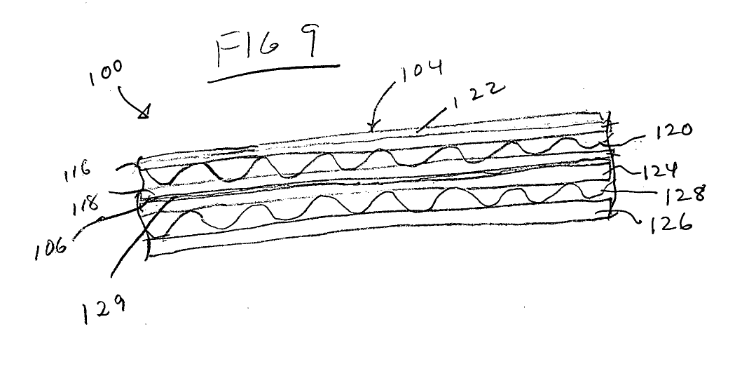

FIG. 7 shows another display board 80 having the same front layer 12 and display surface 14, and having a similar rear layer 82 that has an integral foot 22 and brace arm 50 formed therein. In display board 80, no fluted corrugate is provided between the front layer 12 and rear layer 82, and the rear layer 82 is laminated directly to the laminating surface 16 of front layer 12. Again, the operative principle is that the front layer 12 and rear layer 82 together have sufficient strength to achieve a display board 80 with acceptable sag and bend, and the rear layer 82 provides an integral foot 22 and brace arm 50 for supporting the display board 80 in a display position.

The display boards 10, 80, however, are further advantageous in that the display boards may be used in a self-supporting easel mode by deploying the integral feet and brace arms. With reference to FIG. 3, the sides 28, 30 and distal end 32 of the integral foot 22 are separated from the remaining portion of the rear layer 20 along the cut line 26, and the rectangular fill piece 46 is bent from the integral foot along the cut line 42, to expose the slot 44 to accommodate the distal end 58 of the brace arm. The integral foot 22 is folded or is extended outwardly by folding at the fold line 40. The sides 54, 56 and distal end 58 of the brace arm 20 are also separated from the remaining portion of the rear layer along the cut line 52, and are folded outwardly at the fold line 62. The distal end 58 of the brace arm 50 forms a tab that is inserted in the slot 44. The tab and rectangular opening are shaped and configured for interengagement, so that the brace arm 50 holds the integral foot 20 in its outwardly angled deployed position.

With respect to FIG. 4, the display board 10 may be supported in landscape orientation, with the edge 36 of the distal foot end 32 resting on the surface on which the display board 10 is supported. With reference to FIG. 5, the display board 10 may also be supported in portrait orientation by the integral foot 22, with edge 34 the distal end of the integral foot on the surface. The display board 80 may be similarly supported.

With reference to the FIGS. 8-11, another display board 100 according to the invention herein is illustrated. It has a front layer 102 having a display surface 104 and a laminating surface 106 opposite the display surface 104. The display board 100 also has a rear layer 110 having an integral foot 112 and an integral brace arm 114. As more fully discussed below, the integral foot 112 and brace arm 14 may be deployed to support the display board 100 in a standing position.

With reference to FIG. 9, which is a sectional view of the display board 100 taken along the lines 9-9 of FIG. 8, the composition and construction of the front layer 102 and rear layer 110 are shown. The front layer 102 is a corrugated panel, having paperboard skins 116 and 118 connected by corrugate flute 120. The skin 118 provides the laminating surface 106 of the front layer 102. The display surface 104 is provided by a paper display sheet 122, which is adhered to the skin 118. The paper display sheet may be provided in a white or other colors such as black, blue, red, green, etc. The display sheet 122 can also be provided by other substrates, such as plastics or vinyls.

The rear layer 110 is also a corrugated panel, having paperboard skins 124 and 126 connected by corrugate flute 128. The surface of paperboard skin 124 is adhered to the paperboard skin 118 of the front layer 102 by adhesive 129, to laminate the front and rear layers together. If desired, the paperboard skin 126 of the rear layer 102 may be covered by colored paper sheet or another sheet material to improve the appearance thereof; however, the rear layer 102 is generally not used as a display and the additional sheet is not necessary to the structure or function of the display board. It should also be known that the display surface 104 may be provided by a coating on the surface of paperboard skin 116, such as a heavy clay coating or the like, in lieu of a separate sheet.

The integral foot 112 has a distal end 130 having edges 132 and 134 aligned with adjacent corner edges of the front layer 102. The integral foot 112 also has a proximate end 136 hingedly connected with the rear layer 110 at a fold line 137. The integral foot is further defined by edges 138 and 139 extending from the ends of the fold line 137 to the distal end 130. A notch 140 is formed along the edge 138 of the integral foot 112. A portion of the brace arm extends across the edge 138, as more fully discussed below.

The brace arm 114 has proximate end 142 hingedly connected with the remaining portion of the rear layer 110 at a fold line 144. The fold line 144 is advantageously located extending from the side 138 of the integral foot 112 at the notch 140. The distal end 146 of the brace arm 114 is provided with a tab 148 and a notch 150 adjacent the tab 148. A portion 152 of the edge 138 of the integral foot 112 is angled from the top of notch 140 to the top of notch 150. The tab 148 extends into the integral foot 112. An access opening 154 is cut into the rear layer 110 adjacent the brace arm 112, to facilitate lifting the brace arm from the rear layer 110.

The integral foot 112 and the brace arm 114 are formed in the rear layer 110 by cut lines and by the fold lines 140 and 144. They are not laminated to the front layer 102, whereas a sufficient amount of the remaining portion of the rear layer 110 is secured to the front layer 102 by adhesive 129 or the like. It is desirable to secure most of the front layer and rear layer together except for the integral foot 112 and brace arm 114, although the corrugated layers are relatively stiff and sufficiently self supporting that the adhesive 129 does not need to be applied to the entire laminating surface 106.

The nature of the corrugated structure of the rear panel is such that the integral foot 112 and brace arm 114 tend to remain co-planer with the rear layer 112 until the user pivots them to an open position; however, small discontinuities in the cuts defining the integral foot 112 and brace arm 114 may be provided to better hold them in place, and small amounts of adhesive can be used for that purpose.

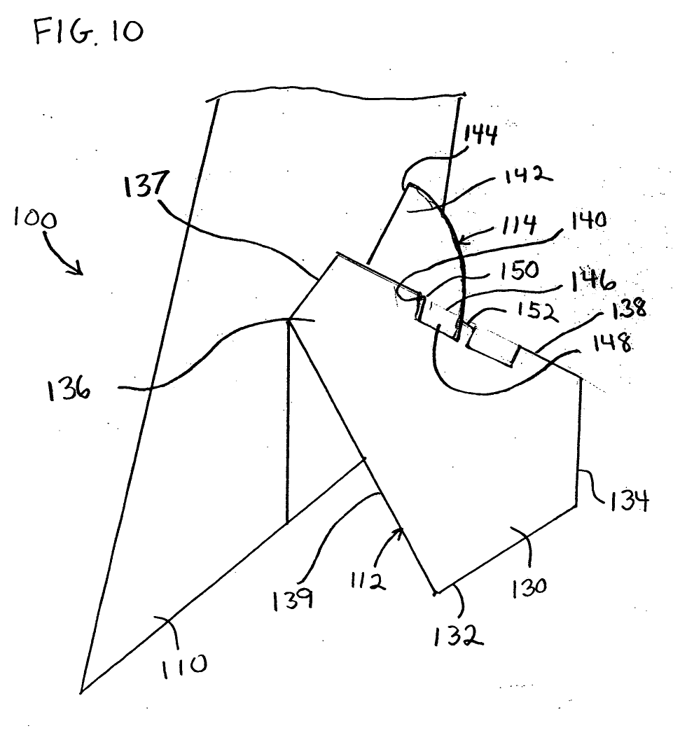

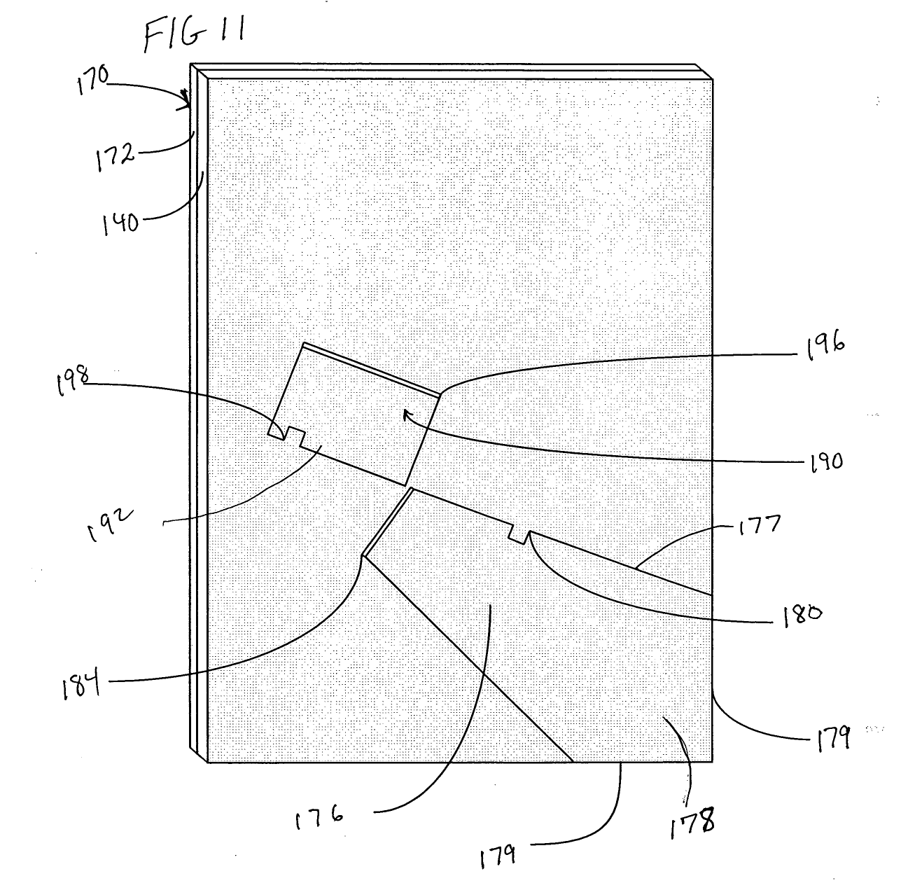

FIG. 10 shows the display board 100 erected. This is accomplished by first folding the integral brace arm 114 outwardly from the rear layer 110. The integral foot 112 is then folded outwardly from the rear layer 110. Because the notch 140 is adjacent the fold line 139, the notch 140 slides along the brace arm edge until the notches 140 and 150 interengage. This secures the integral foot 112 in a position that supports the display board on a table top or the like.

In FIG. 10, the display board is supported in portrait orientation, by edge 132 of the integral foot 112, but it will be appreciated that the display board 100 could also be supported in landscape orientation, with edge 134 on the table or other flat supporting surface.

The display board 100 is rectangular and may be either the relatively standard size of 24 inches by 32 inches, or any other desired size. The corrugated front layer 102 and corrugated rear layer 110 are in and of themselves relatively stiff, and therefore provide a stiff display board 100 and the corrugated construction of the front layer and the rear layer also provides a display board that is of relatively light weight.

With reference to FIG. 11, another display board 170 according to the invention herein is shown in a rear plan view. It has a front layer 172 and having a display surface, not seen, in FIG. 11, and a rear layer 174 laminated to the front layer 172 by adhesive or the like. An integral foot 176 is formed from a portion of the rear layer 174 by cut lines 177, and the integral foot 176 extends to an integral foot end 178 aligned with adjoining corner edges of the display board 170 as described above with respect to display board 100. The cut line 177 partially defining the integral foot includes a notch 180. The integral foot 176 has a proximate end 182 which joins with the rear layer 174 at a fold line 184. A brace arm 190 is also formed by a portion of the rear layer 174, and includes a distal end 192 and a proximate end 194 at a fold line 196. The brace arm defines a notch 198.

When the integral foot 176 and brace arm 190 are folded outwardly and thereby deployed, the notch 198 of the brace arm engages with the notch 180 of the integral foot, wherein the brace arm 190 holds the integral foot 176 in the desired position for supporting the display board 170 on a flat surface in either portrait or landscape orientation. Therefore, FIG. 11 shows a display board 170 wherein the brace arm has a different shape and location with respect to the integral foot then in the embodiments described above, illustrating flexibility and options in design of the integral foot and brace arm.

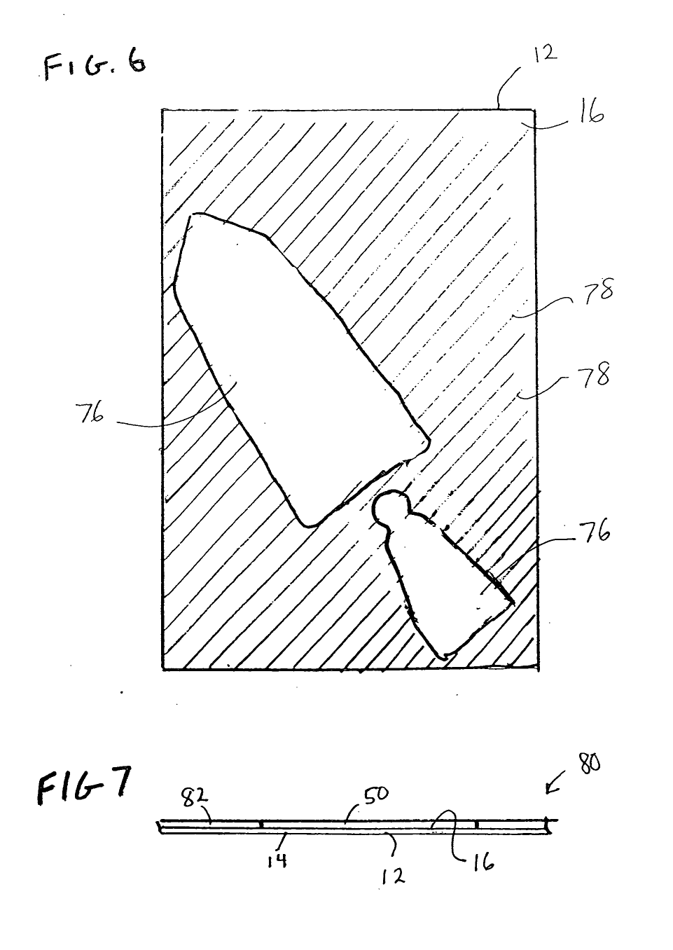

In the display boards 10, 80, 100 and 170 the rear layers 20, 82, 110 and 174 are respectively adhered to the laminating surfaces of the front layers. However, the integral feet and the brace arms are not adhered to the front layer, so that they can be deployed. As illustrated in FIG. 6 with respect to display board 10, this is accomplished by applying adhesive to areas other than the areas 76 of the integral foot 22 and brace arm 50. Adhesive 78 is applied to the laminating surface 16, and the adhesive may be applied using a die with the areas of the integral foot 22 and brace arm 50 having corresponding blank areas on the die, except that a small portion of adhesive may be applied to the area 76 of the integral foot and brace arm for releasably securing them. The rear layer 20 is positioned on the laminating surface 16 of the front layer 12, with the adhesive securing the front layer 12 and rear layer 20 together but without securing the integral foot 22 and brace arm 50 to the front layer, except in a small releasable area, if desired. The same procedure may be used to laminate rear layers to the front layers of display boards 80, 100 and 170.

If appropriate equipment is available, adhesive may be applied without using a die. The adhesive may be applied to either the front panel or the rear panel. One or more spots of adhesive may be positioned to releasably hold the integral foot and brace arm. The releaseable securement of the integral foot 22 and brace arm 50 may be achieved by application of two-sided tape and is, of course, not necessary if tear-away webs 50 are used. The cut lines 26, 42 and 52 may be formed in the rear layers either before or after the laminating step.

In using the display boards 10, 80, 100 and 170, they may be placed on a flat surface for the application of indicia and images comprising information to be presented. The indicia and images may include lettering, numbers, pictures, and may also include additional materials secured to the display surfaces, such as pictures or text printed on paper. Everything that might be placed on a prior art poster board can be placed on the display surface 14. At this point, the integral feet and brace arms are not deployed, such that the display boards are completely flat while the indicia and images are applied. If desired, the display boards may be used in this flat configuration, in the same manner as a prior art poster board. For instance, they can be hung on a wall with push pins or tape, or may be placed on an easel.

Accordingly, the easel display boards with two way integral foot described above admirably fulfill the objects of the invention herein. It will be appreciated that the embodiments described above are illustrative of the invention, and that various changes may be made without disparting from the spirit and the scope of the invention, which is defined in the following claims.

I claim:

1. A display board comprising;
A) a front layer including a display surface for receiving indicia and images and a laminating surface opposite the display surface;
B) a rear layer having substantially the same size and shape as the front layer, the rear layer having an integral foot with a proximate foot end integrally hingidly connected to the remaining part of the rear layer at a fold line and separated from the remaining rear layer by a cut line, the integral foot having a distal foot end; and
C) the rear layer adhered to the laminating surface to the front layer with the integral foot thereof not laminated to the front layer, wherein the integral foot is foldably extendable from the rear layer to a position supporting the display board in a generally upright position on a surface with the distal foot end of the integral foot engaging the surface.

2. A display board as defined in claim 1 and further comprising:
D) brace means extendable from the rear layer and engageable with the integral foot to establish a fixed extended position of the integral foot.

3. A display board as defined in claim 2 wherein the brace means is a brace arm integral with the rear layer and has and is separated from the remaining portion of the rear layer by a cut line and a proximate end integrally hingedly connected to the remaining portion of the rear layer at a fold line, the brace arm not laminated to the front layer, the brace arm and the integral foot configured for interengagement to establish the fixed extended position of the integral foot.

4. A display board as defined claim 3 wherein the integral foot defines a slot opening receiving a distal end of the brace arm to connect the brace arm to the integral foot and establish the fixed extended position of the integral foot.

5. A display board as defined in claim 3 wherein the integral foot and the brace arm define respective notches that interengage to establish the fixed extended position of the integral foot.

6. A display board as defined in claim 5 wherein the brace arm includes a distal tab adjacent the brace arm notch, and the distal tab buttingly engages the integral foot when the integral foot is deployed in its fixed extended position.

7. A display board as defined in claim 5 wherein a portion of the rear layer adjacent the brace arm is cut out to facilitate deploying the brace arm.

8. A display board as defined in claim 5 wherein the fold line at the proximate end of the brace arm is aligned with the notch in the integral foot.

9. A display board as defined in claim 6 wherein the brace arm includes a distal tab adjacent the brace arm notch, and the distal tab buttingly engages the integral foot when the integral foot is deployed in its fixed extended position.

10. A display board as defined in claim 3 wherein the front layer and rear layer are rectangular and the extended position of the integral foot supports the display board in portrait or landscape orientation.

11. A display board as defined in claim 10 wherein the distal foot end has two edges respectively aligned with adjoining corner edges of the front layer prior to deploying the integral foot.

12. A display board as defined in claim 3, wherein the cut lines separating the integral foot and the brace arm from the remaining portions of the rear layer are discontinuous cut lines including tear-away webs providing for deployment of the integral foot and brace arm.

13. A display board as defined in claim 3 wherein the integral foot and brace arm are releaseably secured to the front layer by one or more spots of adhesive.

14. A display board as defined in claim 3 wherein the integral foot and brace arm are releaseably secured to the front layer by two sided tape.

15. A display board as defined in claim 1 wherein the front layer and rear layer are rectangular and the extended position of the integral foot supports the display board in portrait or landscape orientation.

16. A display board as defined in claim 1 wherein the front layer is paperboard with the display surface thereof is coated to receive indicia and images.

17. A display board as defined in claim 1 wherein the rear layer has a paperboard panel and fluted corrugate adhered thereto, and the fluted corrugate is laminated to the laminating surface of the front layer.

18. A display board as defined in claim 1 wherein the rear layer is paperboard laminated to the laminating surface of the front layer.

19. A display board as defined in claim 1 wherein the cut lines defining the integral foot are at least in part discontinuous to form webs for holding releasably attaching the integral foot to the remaining portion of the rear layer until the integral foot is deployed.

20. A display board as defined in claim 3 wherein the front layer and the rear layer are each corrugated panels having paperboard skins with fluted corrugate therebetween.

21. A method of making the display board of claim 1 including:
A) applying adhesive to one of the front and rear layers in an area not including the location of the integral foot and brace arm; and
B) positioning the rear layer on the laminating surface of the front layer with the integral foot and brace arm in locations where adhesive was not applied.

22. The method of claim 21 wherein the adhesive is applied with a die having a substantially non-adhesive applying area corresponding to the integral foot and brace arm.

23. The method of claim 22 wherein the die applies an amount of adhesive to the locations of the integral foot and brace arm sufficient to releaseably adhere the integral foot to the front layer.

24. The method of claim 21 and further comprising:
C) applying an amount of adhesive to the locations of the integral foot and brace arm sufficient to releaseably adhere the integral foot to the front layer.
